(19) United States
(12) Patent Application Publication
(10) Pub. No.: US 2012/0018923 A1
(43) Pub. Date: Jan. 26, 2012

(54) SYSTEM AND METHOD FOR FORMING A CERAMIC SCINTILLATOR

(76) Inventors: Haochuan Jiang, Brookfield, WI (US); Kevin Alan David, Waterford, WI (US)

(21) Appl. No.: 12/839,656

(22) Filed: Jul. 20, 2010

(51) Int. Cl. B29C 43/02

(52) U.S. Cl. 264/319; 425/197

(57) ABSTRACT

A manufacturing line for fabricating a scintillator that includes a vat configured to receive a mixture of scintillator components. The mixture includes a dissolved acid solution comprising a rare earth element, a gallium compound, an aluminum compound, and a cerium salt. The vat is further configured to react a base solution with the mixture to form a precipitate. The manufacturing line further includes a separator configured to separate the precipitate from a remaining portion of the mixture, and a compaction device configured to compact the precipitate to form a green ceramic wafer.

### BACKGROUND OF THE INVENTION

Embodiments of the invention relate generally to a scintillator for x-ray detection and more particularly to an apparatus and method of fabricating a scintillator.

Typically, an imaging system such as a computed tomography or an x-ray imaging system includes an x-ray source positioned to emit x-rays toward a detector, and an object positioned therebetween. In such systems the detector includes a scintillator that is configured to illuminate and emit photons when x-rays impinge thereon. Thus, although a computed tomography (CT) imaging system is described below with respect to the invention, the invention is applicable to an apparatus and method of fabricating a scintillator for any imaging system that uses a scintillator.

In CT imaging systems, an x-ray source emits a fan-shaped beam toward a subject or object, such as a patient or a piece of luggage. Hereinafter, the terms “subject” and “object” shall include anything capable of being imaged. The beam, after being attenuated by the subject, impinges upon an array of radiation detectors. The intensity of the attenuated beam radiation received at the detector array is typically dependent upon the attenuation of the x-ray beam by the subject. Each detector element of the detector array produces a separate electrical signal indicative of the attenuated beam received by each detector element. The electrical signals are transmitted to a data processing system for analysis which ultimately produces an image.

Generally, the x-ray source and the detector array are rotated about the gantry within an imaging plane and around the subject. X-ray sources typically include x-ray tubes, which emit the x-ray beam at a focal point. X-ray detectors typically include a collimator for collimating x-ray beams received at the detector, a scintillator for converting x-rays to light energy adjacent the collimator, and photodiodes for receiving the light energy from the adjacent scintillator and producing electrical signals therefrom.

Typically, each scintillator of a scintillator array converts x-rays to light energy. Each scintillator discharges light energy to a photodiode adjacent thereto. Each photodiode detects the light energy and generates a corresponding electrical signal. The outputs of the photodiodes are then transmitted to the data processing system for image reconstruction. Some known scintillators include a rare earth based ceramic garnet scintillator material that is based on mixing raw materials mechanically. Typically the rare earths include Gd, Y, Lu, La, and Sc, as is known in the art. In a Gd-based compound of this known scintillator, the chemical structure is Gd—Ga—Al—O:Ce.

In attempts to obtain material homogeneity and uniformity in fabrication of this scintillator, the raw material oxides or salts are typically mixed by ball milling or other mechanical means. The mixture is then thermally treated to make a ceramic material. However, several drawbacks of this process may include a high cost and more than a desired amount of yield loss.

Ball milling and other mechanical mixing means is not capable of mixing to achieve an atomic level of homogeneity that is desired by a high performance scintillator. In order to regularly meet performance goals in a garnet ceramic scintillator, the material typically should have a pure garnet crystal phase that provides a homogeneous host for scintillation centers. The homogeneity is characterized by the chemical composition uniformity, and samples of a few nanometers are typically tested to provide an entire representation of the bulk material.

Ball milling and other mechanical mixing means may also introduce contamination into the final scintillator product. Mechanical mixing such as ball milling uses milling media made of a material that is different from the scintillator material. Thus, intense mechanical actions (such as impact between balls, impact between balls and a container, etc.) inevitably cause wear of the milling media and also the container. Material of the milling media and the container may be carried away by the scintillator material and incorporated into the final scintillator structure. This unwanted contamination into the scintillator material can cause performance degradation of the scintillator.

Ball milling and other mechanical mixing means may also have difficulty in controlling the composition of the scintillator. Milling media made of alumina may be used to reduce heavy contamination of the scintillator material. While an introduction of aluminum from the milling media into the scintillator material may be considered permissible because aluminum is a component of the final scintillator, the wear of alumina milling media can introduce excess aluminum into the final scintillator material, however, thus moving the composition and particularly the amount of aluminum therein outside of the desired range. This may be compensated, to some extent, by subtracting an amount of aluminum or aluminum oxide that is introduced into the mixture as a raw component. However, this is typically an unreliable solution, as the amount of alumina that may be introduced in the milling process through contamination can be highly unpredictable.

Therefore, it would be desirable to design an apparatus and method of fabricating a scintillator that reduces the introduction of excess material into the scintillator material during fabrication that results in a composition change of the scintillator material.

### BRIEF DESCRIPTION OF THE INVENTION

The invention is a directed system and method for forming a ceramic scintillator.

According to one aspect of the invention, a manufacturing line for fabricating a scintillator that includes a vat configured to receive a mixture of scintillator components. The mixture includes a dissolved acid solution comprising a rare earth element, a gallium compound, an aluminum compound, and a cerium salt. The vat is further configured to react a base solution with the mixture to form a precipitate. The manufacturing line further includes a separator configured to separate the precipitate from a remaining portion of the mixture, and a compaction device configured to compact the precipitate to form a green ceramic wafer.

According to another aspect of the invention, a method of fabricating a scintillator includes mixing a rare earth compound with an acid to form a dissolved acid solution, and mixing the dissolved acid solution with a plurality of materials to form a first mixture. The plurality of materials includes a gallium compound, an aluminum compound, and a cerium salt. The method further includes mixing a base solution with the first mixture to form a homogeneous metal salt solution, separating a precipitate from the homogeneous metal salt solution, heat treating the separated precipitate, and compacting the heat treated precipitate to form a green ceramic wafer.

According to yet another aspect of the invention, a process for fabricating a ceramic scintillator includes forming a dissolved acid solution that comprises a rare earth compound, mixing a gallium compound, an aluminum compound, and a cerium salt into the dissolved acid solution to create a metal salt solution, mixing a base into the metal salt solution to form a mixture, extracting a precipitate from the mixture, reducing a particle size of the particulate via one of freeze-drying and air milling, and compacting the precipitate after particle size reduction and heat treatment to form a green ceramic wafer.

Various other features and advantages will be made apparent from the following detailed description and the drawings.

### BRIEF DESCRIPTION OF THE DRAWINGS

In the drawings:

FIG. 1 is a pictorial view of a CT imaging system.

FIG. 2 is a block schematic diagram of the system illustrated in FIG. 1.

FIG. 3 is a perspective view of one embodiment of a CT system detector array.

FIG. 4 is a perspective view of one embodiment of a detector.

FIG. 5 is a technique for fabricating a rare earth based garnet ceramic scintillator material.

FIG. 6 is a manufacturing line for fabricating a rare earth based garnet ceramic scintillator material.

FIG. 7 is a pictorial view of a CT system for use with a non-invasive package inspection system.

### DETAILED DESCRIPTION OF THE PREFERRED EMBODIMENT

The operating environment of the invention is described with respect to a sixty-four-slice computed tomography (CT) system. However, it will be appreciated by those skilled in the art that embodiments of the invention are equally applicable for use with other multi-slice configurations. Moreover, the invention will be described with respect to the detection and conversion of x-rays. However, one skilled in the art will further appreciate that the invention is equally applicable for the detection and conversion of other high frequency electromagnetic energy. The invention will be described with respect to a “third generation” CT scanner, but is equally applicable with other CT systems.

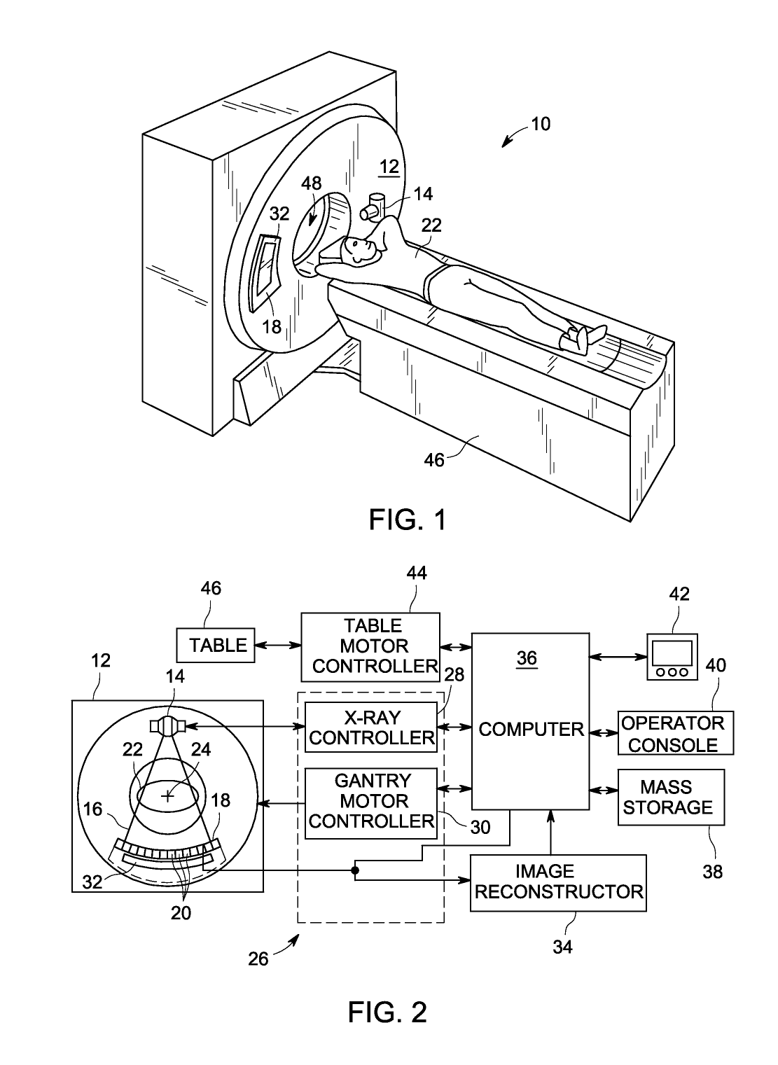

Referring to FIG. 1, a computed tomography (CT) imaging system 10 is shown as including a gantry 12 representative of a “third generation” CT scanner. Gantry 12 has an x-ray source 14 that projects a beam of x-rays toward a detector assembly or collimator 18 on the opposite side of the gantry 12. Referring now to FIG. 2, detector assembly 18 is formed by a plurality of detectors 20 and data acquisition systems (DAS) 32. The plurality of detectors 20 sense the projected x-rays 16 that pass through a medical patient 22, and DAS 32 converts the data to digital signals for subsequent processing. Each detector 20 produces an analog electrical signal that represents the intensity of an impinging x-ray beam and hence the attenuated beam as it passes through the patient 22. During a scan to acquire x-ray projection data, gantry 12 and the components mounted thereon rotate about a center of rotation 24.

Rotation of gantry 12 and the operation of x-ray source 14 are governed by a control mechanism 26 of CT system 10. Control mechanism 26 includes an x-ray controller 28 that provides power and timing signals to an x-ray source 14 and a gantry motor controller 30 that controls the rotational speed and position of gantry 12. An image reconstructor 34 receives sampled and digitized x-ray data from DAS 32 and performs high speed reconstruction. The reconstructed image is applied as an input to a computer 36 which stores the image in a mass storage device 38.

Computer 36 also receives commands and scanning parameters from an operator via console 40 that has some form of operator interface, such as a keyboard, mouse, voice activated controller, or any other suitable input apparatus. An associated display 42 allows the operator to observe the reconstructed image and other data from computer 36. The operator supplied commands and parameters are used by computer 36 to provide control signals and information to DAS 32, x-ray controller 28 and gantry motor controller 30. In addition, computer 36 operates a table motor controller 44 which controls a motorized table 46 to position patient 22 and gantry 12. Particularly, table 46 moves patients 22 through a gantry opening 48 of FIG. 1 in whole or in part.

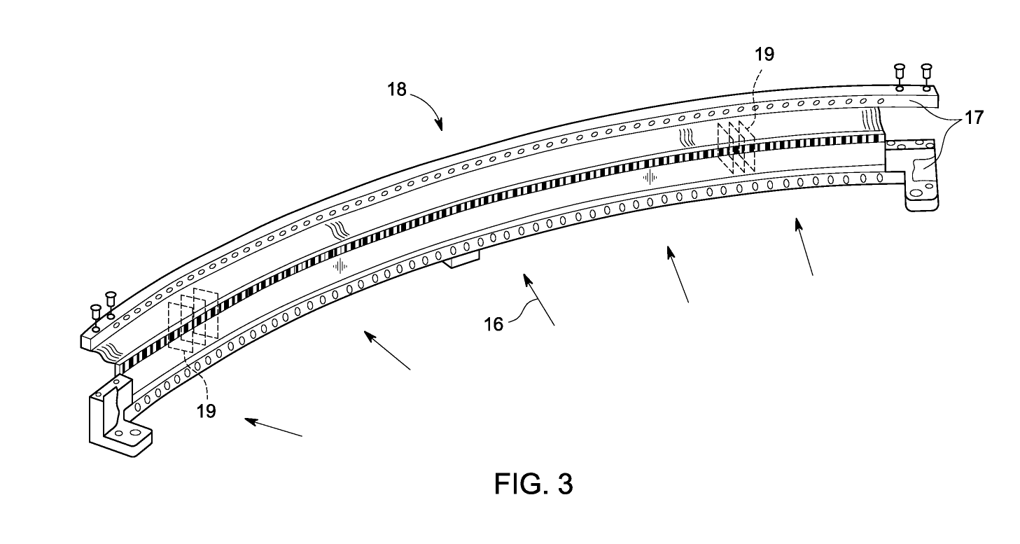

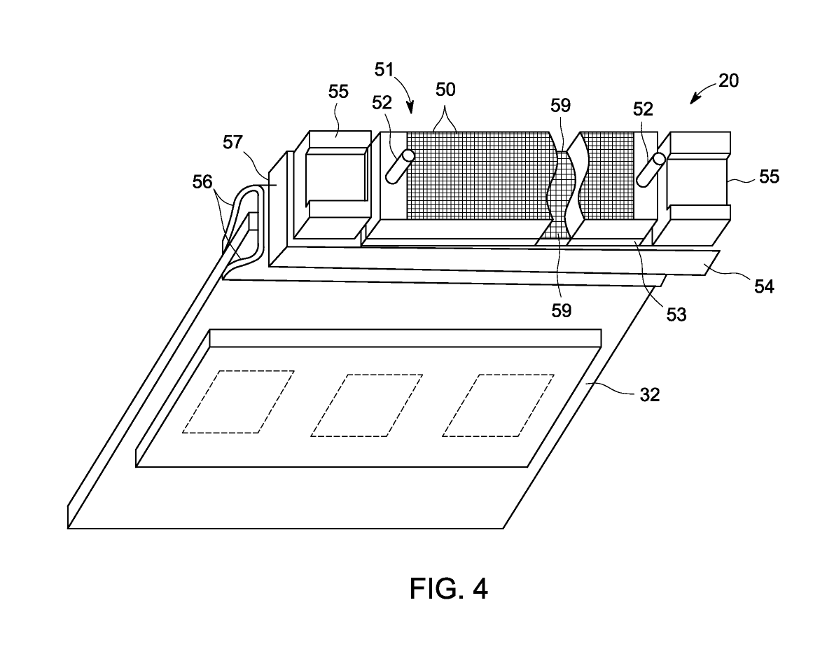

As shown in FIG. 3, detector assembly 18 includes rails 17 having collimating blades or plates 19 placed therebetween. Plates 19 are positioned to collimate x-rays 16 before such beams impinge upon, for instance, detector 20 of FIG. 4 positioned on detector assembly 18. In one embodiment, detector assembly 18 includes 57 detectors 20, each detector 20 having an array size of 64×16 of pixel elements 50. As a result, detector assembly 18 has 64 rows and 912 columns (16×57 detectors) which allows 64 simultaneous slices of data to be collected with each rotation of gantry 12.

Referring to FIG. 4, detector 20 includes DAS 32, with each detector 20 including a number of detector elements 50 arranged in pack 51. Detectors 20 include pins 52 positioned within pack 51 relative to detector elements 50. Pack 51 is positioned on a backlit diode array 53 having a plurality of diodes 59. Backlit diode array 53 is in turn positioned on multi-layer substrate 54. Spacers 55 are positioned on multi-layer substrate 54. Detector elements 50 are optically coupled to backlit diode array 53, and backlit diode array 53 is in turn electrically coupled to multi-layer substrate 54. Flex circuits 56 are attached to face 57 of multi-layer substrate 54 and to DAS 32. Detectors 20 are positioned within detector assembly 18 by use of pins 52.

In the operation of one embodiment, x-rays impinging within detector elements 50 generate photons which traverse pack 51, thereby generating an analog signal which is detected on a diode within backlit diode array 53. The analog signal generated is carried through multi-layer substrate 54, through flex circuits 56, to DAS 32 wherein the analog signal is converted to a digital signal.

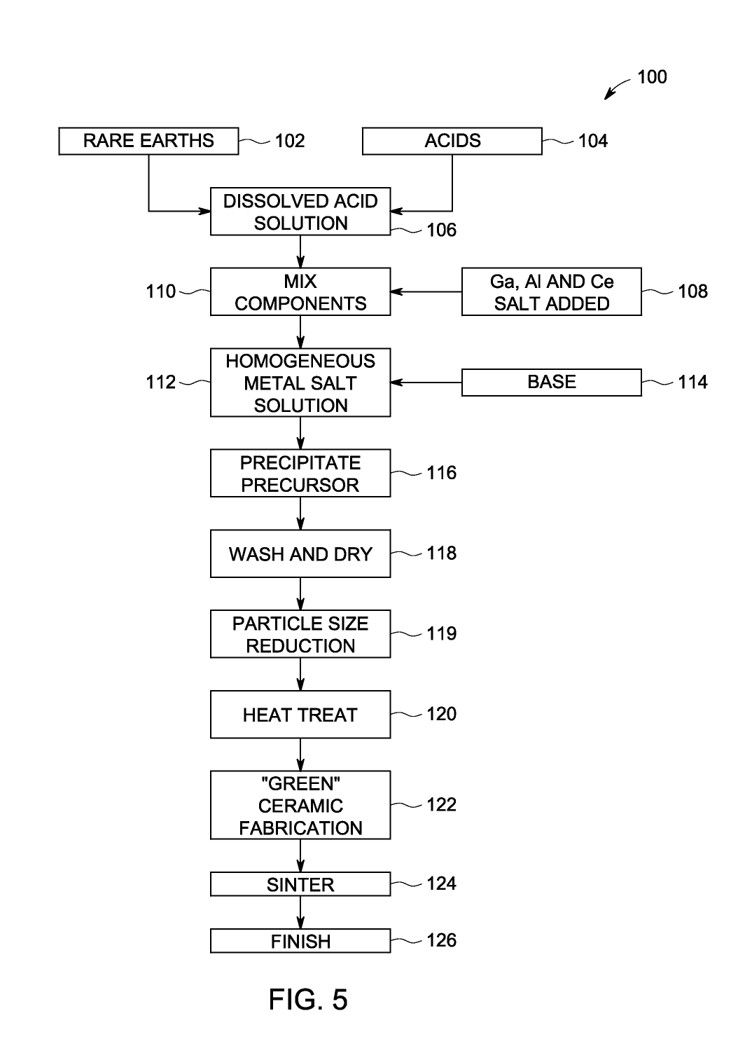

Referring now to FIG. 5, a technique 100 for fabricating a rare earth based garnet ceramic scintillator is disclosed. The rare earth based garnet ceramic scintillator material is, generally, XX—Ga—Al—O:Ce, where XX represents a rare earth element such as gadolinium, yttrium, scandium, and lanthanides such as lanthanum, lutetium, and other lanthanides as understood in the art. At step 102, a rare earth is selected to be dissolved with one or more acids, such as nitric acid, hydrochloric acid, and sulfuric acid, as examples, selected at step 104. The rare earth and acid is combined to form a dissolved acid solution is formed at step 106 having the one or more rare earths dissolved therein.

At step 108, sources of gallium, aluminum, and cerium are selected and mixed with the dissolved acid solution at step 110. According to embodiments of the invention, gallium is added in the form of any number of compounds including, but not limited to, Ga₂O₃, NH₄Ga(SO₄)₂.12H₂O, GaCl₃.xH₂O, Ga(NO₃).xH₂O, and Ga₂(SO₄)₃.xH₂O. According to embodiments of the invention, aluminum is added in the form of any number of compounds including, but not limited to, NH₄Al(SO₄)₂.12H₂O, AlCl₃.xH₂O, Al(NO₃)₃.xH₂O, Al₂(SO₄)₃.xH₂O, and (NH₄Al(OH)₂CO₃). According to embodiments of the invention, cerium is added in the form of any number of compounds including, but not limited to, cerium carbonate, cerium sulfate, cerium nitrate, and cerium chloride. After the mixing of components at step 110, a homogeneous metal salt solution is formed at step 112. A base is added to the homogeneous metal salt solution and reacted therewith, the base selected at step 114. According to embodiments of the invention, the base includes, but is not limited to, ammonium hydroxide, ammonium bicarbonate, ammonium carbonate, or combinations thereof, thus forming a precipitate precursor at step 116. At step 118, the precipitate precursor is washed and dried, and particle size is reduced via a non-mechanical method such as freeze-drying at step 119. When freeze-drying, a wet cake of precipitate is frozen under vacuum, as understood in the art. At step 120, the freeze-dried product is heat treated to form a uniform oxide. In one embodiment of the invention, particle size is reduced via an air milling or jet milling process. Air milling (or jet milling) can be done either prior to heat treating of step 120, or afterward.

Thus, by reducing particle size by either freeze-drying or air milling, a final fluffy powder having little agglomeration may be realized having a good sinterability, while having little or no contamination introduced therein as compared with conventional milling processes that use, for instance, alumina or other milling media. After heat treating at step 120, a “green” ceramic wafer is fabricated at step 122. As understood in the art, a green ceramic wafer is a ceramic in its unfired state. The green ceramic wafer is sintered at step 124, as understood in the art, and the process ends at step 126.

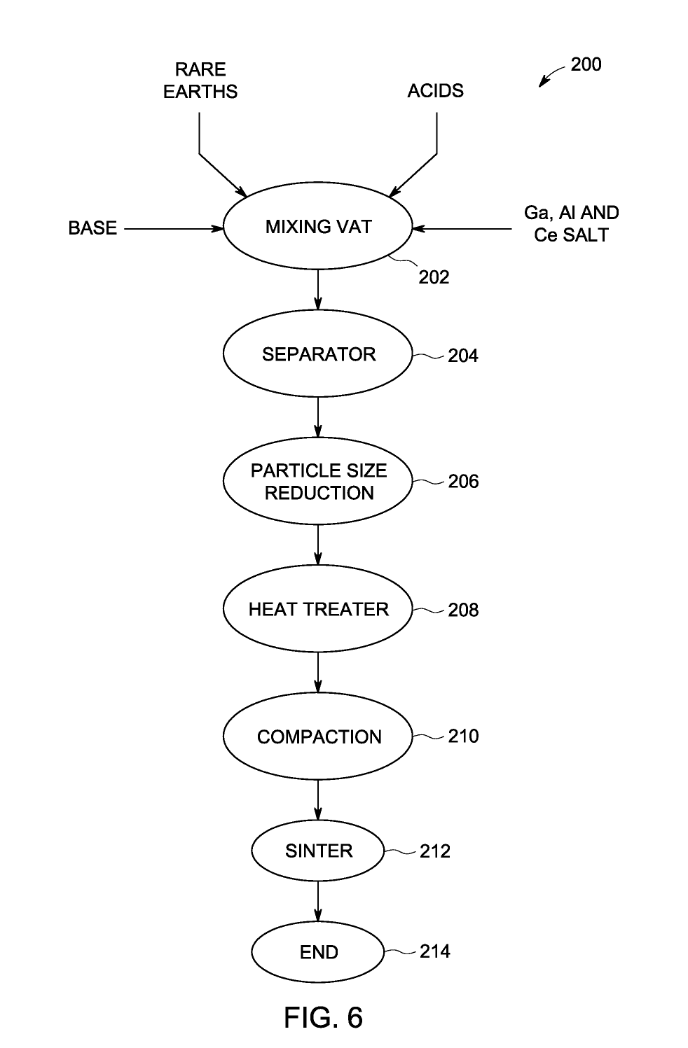

Technique 100 may be implemented in a manufacturing line 200 as illustrated in FIG. 6. FIG. 6 illustrates a number of devices that may be used in a manufacturing process to implement technique 100. However, it is to be understood that the invention is not limited to the devices illustrated in FIG. 6, but that technique 100 may be implemented by using more or less than the devices illustrated or by using equivalent devices. For instance, manufacturing line 200 illustrates a mixing vat 202 into which a base, rare earths, acids, and Ga/Al/Ce source materials are mixed. However, it is to be understood that mixing vat 202 may include multiple sub-stages and that mixing vat 202 is simply illustrative of what may be one or more devices.

Thus, according to embodiments of the invention, mixing vat 202 may include a single vat into which all components are added and mixed, or mixing vat 202 may be divided into sub-stages where, for instance, rare earths and acids are mixed (corresponding to steps 102 and 104 of technique 100) to form a dissolved acid solution as in step 106 of technique 100. After mixing rare earths and acids, the resulting dissolved acid solution may be conveyed to another sub-stage where components may be mixed, corresponding to step 108, and Ga, Al, and Ce source materials may be added thereto. In fact, one skilled in the art will recognize that all such steps may be performed in multiple devices and that the devices illustrated in manufacturing line 200 are simply illustrative of devices which correspond to the steps described in technique 100.

Manufacturing line 200 includes a separator 204, which may remove or filter precipitate that results from the homogeneous metal salt solution formed at step 112 and after base materials are added at step 114. Thus, a powder is separated from liquid, washed and dried in separator 204. Particle size is reduced in a particle size reducing device 206, which, as described above, may be a freeze-dryer or an air mill. The dried powder is heat treated in a heat treater 208.

Powder that has been reduced in size is compacted in compaction device 210 to form a green ceramic wafer as understood in the art. The green ceramic wafer is sintered in device 212, and the process ends 214 where a finished ceramic is ready for final processing into a detector as understood in the art.

Thus, in order to have a good performance garnet ceramic scintillator, a technique and manufacturing line for forming a material having a pure garnet crystal phase that provides a homogeneous host for scintillation centers is described. The homogeneity is characterized by chemical composition uniformity. Thus, in a sample fabricated using the technique and manufacturing line described herein, a sample of a few nanometers in size will represent chemical composition of the bulk material. As such, a wet chemistry based synthesis process as described mixes all elements at the atomic level to ensure complete homogeneity of the final product, which is in contrast to a ceramic fabricated using raw materials powders that are mixed mechanically (such as using ball milling or other mixing methods).

Embodiments of the invention reduce impurity levels in a final product. During precipitation, impurity elements such as sodium, potassium, calcium, and the like, have higher solubility than gadolinium and aluminum, and thus will not precipitate therewith. Thus, a product fabricated as described will have a lower impurity level as compared to processes that do not use a wet chemistry process.

In addition, the wet chemical process as described by technique 100 opens up options for raw materials that are not typically available in a non-wet chemical process. For instance, as illustrated above, numerous salts and oxides may be used as the source for the various elements. This flexibility can lower cost and enable a broader set of suppliers who can meet the rigorous or demanding purity specifications typically required of source materials for fabrication of a scintillator.

The wet chemical process enables an improved control of particle size when compared with scintillator fabrication using a non-wet chemical process. The wet chemical process inherently provides fine particle size, with primary particle sizes typically at sub-micron or nanometer level. By controlling co-precipitation properly, a desired particle size and distribution can be achieved without relying on traditional milling processes.

The wet chemical process ensures a homogeneity of luminescent center elements (i.e., an activator such as cerium). The addition of cerium is fractionally so small that mechanical mixing typically cannot achieve the atomic level mixing homogeneity achieved by the disclosed wet chemical process.

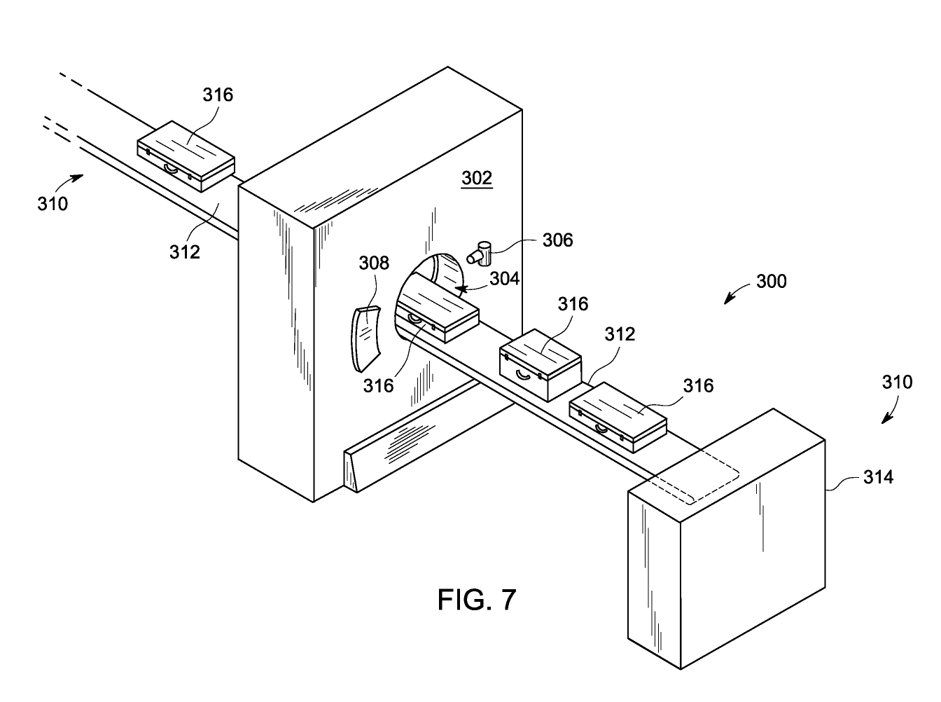

Referring now to FIG. 7, package/baggage inspection system 300 includes a rotatable gantry 302 having an opening 304 therein through which packages or pieces of baggage may pass. The rotatable gantry 302 houses a high frequency electromagnetic energy source 306 as well as a detector assembly 308 having scintillator arrays comprised of scintillator cells similar to that shown in FIGS. 3 and 4. A conveyor system 310 is also provided and includes a conveyor belt 312 supported by structure 314 to automatically and continuously pass packages or baggage pieces 316 through opening 304 to be scanned. Objects 316 are fed through opening 304 by conveyor belt 312, imaging data is then acquired, and the conveyor belt 312 removes the packages 316 from opening 304 in a controlled and continuous manner. As a result, postal inspectors, baggage handlers, and other security personnel may non-invasively inspect the contents of packages 316 for explosives, knives, guns, contraband, etc.

According to one embodiment of the invention, a manufacturing line for fabricating a scintillator that includes a vat configured to receive a mixture of scintillator components. The mixture includes a dissolved acid solution comprising a rare earth element, a gallium compound, an aluminum compound, and a cerium salt. The vat is further configured to react a base solution with the mixture to form a precipitate. The manufacturing line further includes a separator configured to separate the precipitate from a remaining portion of the mixture, and a compaction device configured to compact the precipitate to form a green ceramic wafer.

According to another embodiment of the invention, a method of fabricating a scintillator includes mixing a rare earth compound with an acid to form a dissolved acid solution, and mixing the dissolved acid solution with a plurality of materials to form a first mixture. The plurality of materials includes a gallium compound, an aluminum compound, and a cerium salt. The method further includes mixing a base solution with the first mixture to form a homogeneous metal salt solution, separating a precipitate from the homogeneous metal salt solution, heat treating the separated precipitate, and compacting the heat treated precipitate to form a green ceramic wafer.

According to yet another embodiment of the invention, a process for fabricating a ceramic scintillator includes forming a dissolved acid solution that comprises a rare earth compound, mixing a gallium compound, an aluminum compound, and a cerium salt into the dissolved acid solution to create a metal salt solution, mixing a base into the metal salt solution to form a mixture, extracting a precipitate from the mixture, reducing a particle size of the particulate via one of freeze-drying and air milling, and compacting the precipitate after particle size reduction to form a green ceramic wafer.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A manufacturing line for fabricating a scintillator comprising:
a vat configured to:
receive a mixture of scintillator components, the mixture comprising:
a dissolved acid solution comprising a rare earth element;
a gallium compound;
an aluminum compound; and
a cerium salt; and
react a base solution with the mixture to form a precipitate;
a separator configured to separate the precipitate from a remaining portion of the mixture; and
a compaction device configured to compact the precipitate to form a green ceramic wafer.

2. The manufacturing line of claim 1 comprising a particle size reducing unit configured to receive separated precipitate from the separator.

3. The manufacturing line of claim 2 wherein the particle size reducing unit comprises one of a freeze dryer and an air mill.

4. The manufacturing line of claim 1 comprising a heat treater configured to heat treat the separated precipitate prior to compaction in the compaction device.

5. The manufacturing line of claim 4 comprising a sinterer configured to sinter the compacted precipitate.

6. The manufacturing line of claim 1 wherein the rare earth element of the dissolved acid solution comprises one of gadolinium, yttrium, lutetium, lanthanum, and scandium.

7. The manufacturing line of claim 1 wherein the dissolved acid solution comprises one of nitric acid, hydrochloric acid, and sulfuric acid.

8. The manufacturing line of claim 1 wherein the gallium compound comprises one of Ga₂O₃, NH₄Ga(SO₄)₂.12H₂O, GaCl₃.xH₂O, Ga(NO₃).xH₂O, and Ga₂(SO₄)₃.xH₂O.

9. The manufacturing line of claim 1 wherein the aluminum compound comprises one of NH₄Al(SO₄)₂.12H₂O, AlCl₃.xH₂O, Al(NO₃)₃.xH₂O, Al₂(SO₄)₃.xH₂O, and (NH₄Al(OH)₂CO₃).

10. The manufacturing line of claim 1 wherein the cerium salt comprises one of cerium carbonate, cerium sulfate, cerium nitrate, and cerium chloride.

11. A method of fabricating a scintillator comprising:
mixing a rare earth compound with an acid to form a dissolved acid solution;
mixing the dissolved acid solution with a plurality of materials to form a first mixture, the plurality of materials comprising:
a gallium compound;
an aluminum compound; and
a cerium salt;
mixing a base solution with the first mixture to form a homogeneous metal salt solution;
separating a precipitate from the homogeneous metal salt solution;
heat treating the separated precipitate; and
compacting the heat treated precipitate to form a green ceramic wafer.

12. The method of claim 11 comprising reducing a particulate size of the precipitate to less than 1 micron in diameter via one of a freeze dryer and an air mill.

13. The method of claim 11 wherein mixing the rare earth compound with the acid comprises mixing one of gadolinium, yttrium, lutetium, lanthanum, and scandium with one of nitric acid, hydrochloric acid, and sulfuric acid.

14. The method of claim 11 wherein the gallium compound comprises one of Ga₂O₃, NH₄Ga(SO₄)₂.12H₂O, GaCl₃.xH₂O, Ga(NO₃).xH₂O, and Ga₂(SO₄)₃.xH₂O.

15. The method of claim 11 wherein the aluminum compound comprises one of NH₄Al(SO₄)₂.12H₂O, AlCl₃.xH₂O, Al(NO₃)₃.xH₂O, Al₂(SO₄)₃.xH₂O, and (NH₄Al(OH)₂CO₃).

16. The method of claim 11 wherein the cerium salt comprises one of carbonate, cerium sulfate, cerium nitrate, and cerium chloride.

17. A process for fabricating a ceramic scintillator comprising:
forming a dissolved acid solution that comprises a rare earth compound;
mixing a gallium compound, an aluminum compound, and a cerium salt into the dissolved acid solution to create a metal salt solution;
mixing a base into the metal salt solution to form a mixture;
extracting a precipitate from the mixture;
reducing a particle size of the particulate via one of freeze-drying and air milling; and
compacting the precipitate after particle size reduction to form a green ceramic wafer.

18. The process of claim 17 wherein forming the dissolved acid solution comprises mixing one of gadolinium, yttrium, lutetium, lanthanum, and scandium with one of nitric acid, hydrochloric acid, and sulfuric acid.

19. The process of claim 17 wherein reducing the particle size of the particulate comprises reducing particulate size of the particulate to less than 1 micron in diameter via one of a freeze dryer and an air mill.

20. The process of claim 17 comprising heat treating the extracted precipitate.
